(19) United States
(12) Patent Application Publication
(10) Pub. No.: US 2013/0346509 A1
(43) Pub. Date: Dec. 26, 2013

(54) Digital postal mail gateway

(71) Applicants: David D. Elkins, Moorpark, CA (US); John M. Payne, Laguna Beach, CA (US)

(72) Inventors: David D. Elkins, Moorpark, CA (US); John M. Payne, Laguna Beach, CA (US)

(73) Assignee: ZUMBOX, INC., Los Angeles, CA (US)

(21) Appl. No.: 13/477,091

(22) Filed: May 22, 2012

Related U.S. Application Data
(60) Provisional application No. 61/488,757, filed on May 22, 2011.

(51) Int. Cl. H04L 12/58

(52) U.S. Cl. CPC H04L 12/58
USPC 709/206

(57) ABSTRACT

A digital postal mail connector (or “gateway”) is supported within an enterprise's (a mailer's) digital delivery infrastructure, preferably as a rack-mounted hardware appliance or software install. The digital postal mail gateway interfaces with the mailer's existing print process (e.g., a print stream processor) to automatically create an alternative output stream that is sent as one or more digital files and received online by the mailer's customers in web-based electronic mailboxes.

This application is based on and claims priority to Ser. No. 61/488,757, filed May 22, 2011.

### TECHNICAL FIELD

This disclosure relates generally to digital postal mail services.

### BACKGROUND OF THE RELATED ART

Web-based paperless postal systems are known in the art. These systems are designed to connect transactional, financial and government mailers to consumer households for the delivery and storage of digital postal mail via the Internet. Typically, the digital postal mail delivered by such systems is an exact facsimile of paper mail created from a redirection of the mailer print stream and delivered to a secure, centralized digital mailbox associated with a recipient's street address. A commercial system of this type is Zumbox®, a hosted service operated and managed by Zumbox, Inc. of Los Angeles, Calif.

### BRIEF SUMMARY

A digital postal mail connector (or “gateway”) is supported, preferably within an enterprise's (a mailer's) digital delivery infrastructure, preferably as a rack-mounted hardware appliance or software install. If that infrastructure is cloud-based, the DPMC functionality described herein may be implemented as software-as-a-service (SaaS), or a similar implementation model. The digital postal mail gateway (DPMG, or DPMC) interfaces with the mailer's existing print process (e.g., a print stream processor) to automatically create an alternative output stream that is sent as one or more digital files and received online by the mailer's customers in web-based electronic mailboxes (typically comprising one or more SSL-secured web pages).

The foregoing has outlined some of the more pertinent features of the subject matter. These features should be construed to be merely illustrative.

### BRIEF DESCRIPTION OF THE DRAWINGS

For a more complete understanding of the subject matter and the advantages thereof, reference is now made to the following descriptions taken in conjunction with the accompanying drawings, in which:

FIG. 1 is an exemplary infrastructure for providing a digital mail service;

FIG. 2 illustrates how the digital postal mail gateway of this disclosure interfaces to the digital mail service in FIG. 1;

FIG. 3 illustrates the components of the DPMG of this disclosure;

FIG. 4 illustrates the functional components of the DPMG of FIG. 3;

FIG. 5 illustrates a process flow illustrating the creation of a mailer job;

FIG. 6 illustrates a login page of a web-based interface;

FIG. 7 illustrates a mail sent page of the web-based interface;

FIG. 8 illustrates a job type page of the web-based interface;

FIG. 9 illustrates a first embodiment of a page for use in entering a new job;

FIG. 10 illustrates a second embodiment of a page for use in entering a new job;

FIG. 11 illustrates another portion of the page in the second embodiment for entering a new job;

FIG. 12 illustrates a page for including an insert in the mailer; and

FIG. 13 illustrates a page for including footer potion in the mailer.

### DETAILED DESCRIPTION

The digital postal mail gateway of this disclosure interoperates with a web-based (hosted) paperless postal system. The digital postal mail service (e.g., the Zumbox® paperless postal service) to which the DPMG interfaces is not part of this disclosure directly, and familiarity of that infrastructure and functionality is presumed from the following general description. The gateway is not limited to any particular digital mail service provider or infrastructure solution.

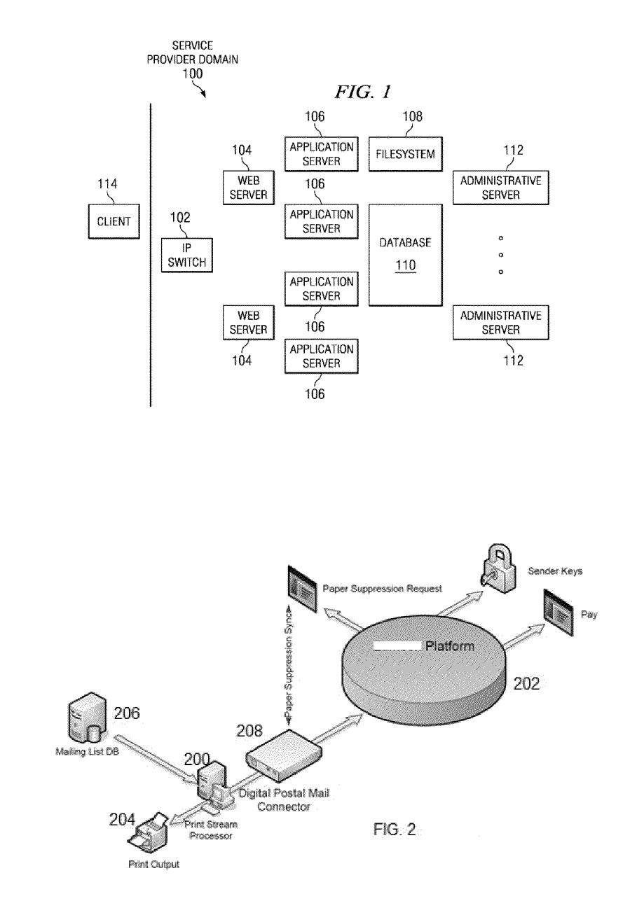

FIG. 1 is a block diagram of one system architecture of a digital postal mail service (e.g., a service available from the Internet domain “www.digitalmailservice.com”) in which the subject matter described herein (the gateway) may communicate. The known digital mail service architecture typically is implemented in or across one or more Internet accessible data centers as a web site (typically, a set of web pages) together with associated applications running behind the site. End users operate Internet-accessible devices (e.g., desktop computers, notebook computers, Internet-enabled mobile devices, smart phones, gesture-based tablets, or other devices having rendering engines, or the like) that are capable of accessing and interacting with the site. An end user machine typically has a web browser or other rendering engine that is compatible with Java, JavaScript, and other Web 2.0 technologies (e.g., AJAX, XHTML, XML, CSS, DOM, JSON, and the like). An end user accesses the site in the usual manner, i.e., by opening the browser to a URL associated with a service provider domain. The user may authenticate to the site (or some portion thereof) by entry of a username and password. The connection between the end user entity machine and the system may be private (e.g., via SSL). Although connectivity via the publicly-routed Internet is typical, the end user may connect to the system in any manner over any local area, wide area, wireless, wired, private or other dedicated network. As seen in FIG. 1, the “server side” of the system 100 preferably comprises an IP switch 102, a set of web servers 104, a set of application servers 106, a file system 108, a database 110, and one or more administrative servers 112. A representative web server is Apache (2.0 or higher) that executes on a commodity machine (e.g., an Intel-based processor running Linux 2.4.x or higher). The machines may execute on multi-core hardware platforms. An application server typically executes the one or more applications that provide the features of the site. The file system 108 preferably is an application level distributed system that operates across a number of servers using an HTTP or other interface. The database 110 may be implemented using MySQL, or any other convenient database management system. The administrator servers 112 handle other back end processes that are used at the site or otherwise to facilitate the service; these back end processes including, for example, user registration, billing, administration, and interoperability with third party sites and systems as may be required. As also seen in FIG. 1, a client 114 communicates with the system using a web browser or other client-side rendering engine.

According to this disclosure, preferably the client 114 in FIG. 1 is a digital postal mail gateway (DPMG) machine or process. More particularly, and referring now to FIG. 2, preferably the DPMG 208 of this disclosure is positioned between a mailer's print stream processor 200 and the web-based paperless postal delivery platform 202. As seen in FIG. 2, the mailer's print stream processor 200 forms part of the mailer's digital delivery infrastructure. That infrastructure typically also includes at least one printer 204, and a mailing list database 206. There may be other machines, devices, processes, interfaces, databases and resources comprising the mailer infrastructure. Typically, that infrastructure is located at or in association with a mailer facility or facilities, although portions thereof may be hosted in a third party data center (e.g., a cloud compute service provider). The particular details of the mailer infrastructure are not part of this disclosure, although one of ordinary skill in the art will appreciate that this infrastructure is adapted and configured to host and interoperate with the gateway in the manner that is described herein.

In that regard, and with reference back to FIG. 2, the digital postal mail connector or gateway 208 DPMG preferably is a network appliance that is configured to securely communicate with the web-based postal mail platform 202. In operation, and preferably using a simple web-based interface, the mailer entity (e.g., an administrator or other permitted user) configures the appliance with the entity's account information. A web-based wizard enables a simple user interface by which the mailer sets up mailing Jobs. A particular Job may involve the digital delivery of a mail piece to a plurality of individuals or business entities associated with the mailer. As will be described, preferably the job is initiated by the user simply dragging and dropping a piece of mail into a “drop folder” (available on a web interface) that has been associated with the network location of the network appliance. Mail is dropped into the folder and delivered via the web-based postal platform.

Preferably, the DPMG is a rack-mounted appliance, although this is not a limitation. The functionality of the gateway described herein may be available as downloadable software (one or more computer programs). In the illustrated embodiment, an appliance of this type is an Internet-accessible computing machine that comprises commodity hardware and software, storage (e.g., disks, disk arrays, and the like) and memory (RAM, ROM, and the like). The appliance includes hardware, network interfaces and software to connect, on one side, to the mailer's print stream processor and, on the other side, to the Internet and thus to the web-based platform service. The appliance also provides a local management console interface for administration, configuration, and management of the device.

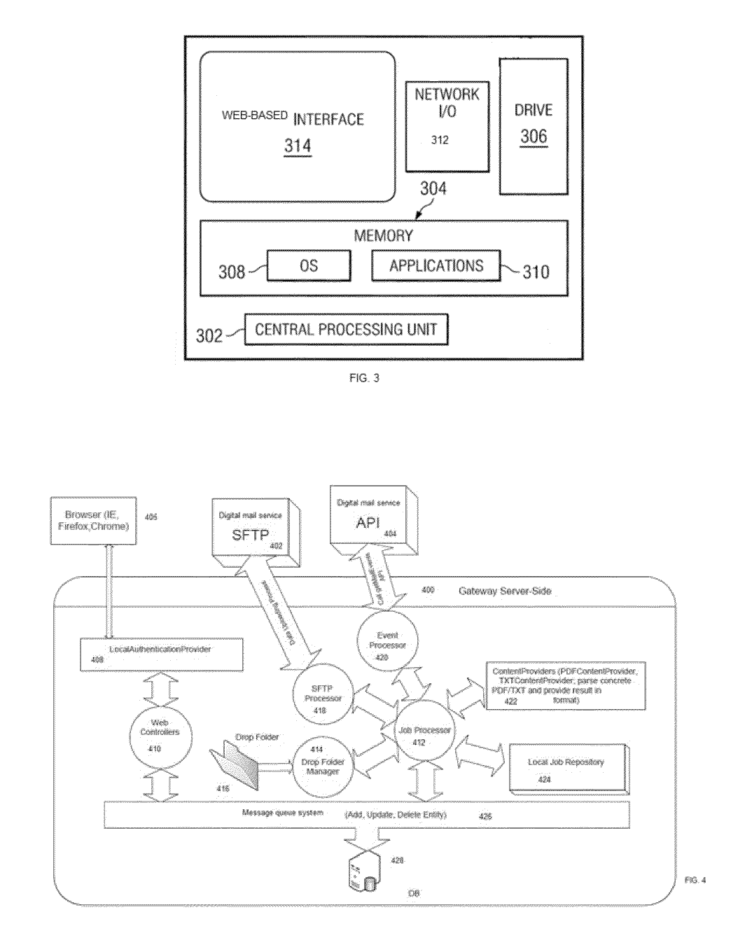

FIG. 3 illustrates a representative DPMG appliance in one embodiment. It includes a CPU 302, computer memory 304 supporting an operating system 308 and one or more applications 310, one or more physical storage drives 306, a network I/O controller 312, and a web-based interface 314.

FIG. 4 illustrates the appliance 400 in more detail. The appliance interfaces with a secure FTP (sFTP) service 402 associated with the digital mail service, as well as an application programming interface 404 associated with the service. The sFTP service 402 is used to communicate the digital mail pieces that are to be delivered by the service, and the API interface 404 enables the digital mail service to obtain and provide control information, data, and the like. One or more client browsers 405 communicate with a local authentication provider service 408 of the gateway. The service 408 authenticates users (typically via entry of user credentials such as user identifier/password), enabling access to the web-based interface 410. A job processor 412 operates continuously, waiting for work. A drop folder manager 414 looks for new jobs entered into the drop folder 416. Jobs are queued in a local job repository 424. One or more routines 422 are provided to convert mail pieces received in one format (e.g., PDF) into formats that are deliverable by the digital mail service. An sFTP processor 418 communicates with the sFTP interface 402, and an event processor 420 communicates with the service API 404. A message queuing system 426 provides an input layer to a database 428.

In operation, the gateway (via its web-based interface) receives the mail job and creates content that is in a format in which it can be consumed by the digital mail service. Once configured, the appliance operates autonomously and without user interaction (other than to drop mail into the drop folder. In operation, the drop folder 416 is associated with any accessible network path within or associated with the mailer's infrastructure. The drop folder manager 414 continually looks for new mail jobs dropped into the drop folder; once a job is dropped, the job processor uses the routine 422 to perform any necessary conversion and then automatically delivers the mail to the digital mail service (via the SFTP interface). Using the event processor and the service API, the gateway can pull event data from the service (e.g., how many users viewed the mail piece, how many users printed the mail piece, or the like).

Drop folder processing by the gateway preferably proceeds as follows. Each time a new job is created, preferably a new drop folder is specified. Once saved, a new process is started to monitor the drop folder. Periodically, the process checks for new files. Each time a new file is detected, the file size is noted. The process checks the file again, e.g., every minute, until it determines that the file system is no longer changing. At this point, since the file is complete, it is moved to a system processing folder. A new mailer record is created, and mailer processor for the specified job type begins.

FIG. 5 illustrates how the job processor 412 interacts with the drop folder manager 414 and the SFTP processor 418 upon dropping of a PDF in the drop folder 416. This is just an example scenario. In this example, a single PDF is dropped in the folder. This is step 500. At step 502, the PDF is processed based on job type rules. In this example scenario, it is assumed that the mailer comprises individual PDFs as well as other data (e.g., data available from a CSV file). Thus, at step 504, the various component parts of the mailer are created as needed and the resulting files are aggregated and zipped (at step 506) into a file called job.zip 508. A piece of footer HTML is added at step 510 and the resulting mailer delivered via the sFTP interface at 512 to complete the process. In more detail, and with reference to FIG. 5, each new PDF copied into a drop folder is processed based on the rules by the job type for that drop folder:

A job folder in the drop folder, named with a unique job id

The PDF is moved to the folder

The PDF is processed and converted into the following files
Individual PDF files
   Break the main PDF up based on the page break rules
   Append an Insert to each individual file if necessary
DAD file, a new record in the CSV is created for each individual file
HTML Footer if specified is copied down to the job folder

Generate the zip file
DAD file goes into zip file
Individual files go into zip file
HTML footer file goes into zip file

Upload zip file to sFTP location using the service credentials provided

Upload .complete file to sFTP location using the service credentials provided
Only after zip file upload completes

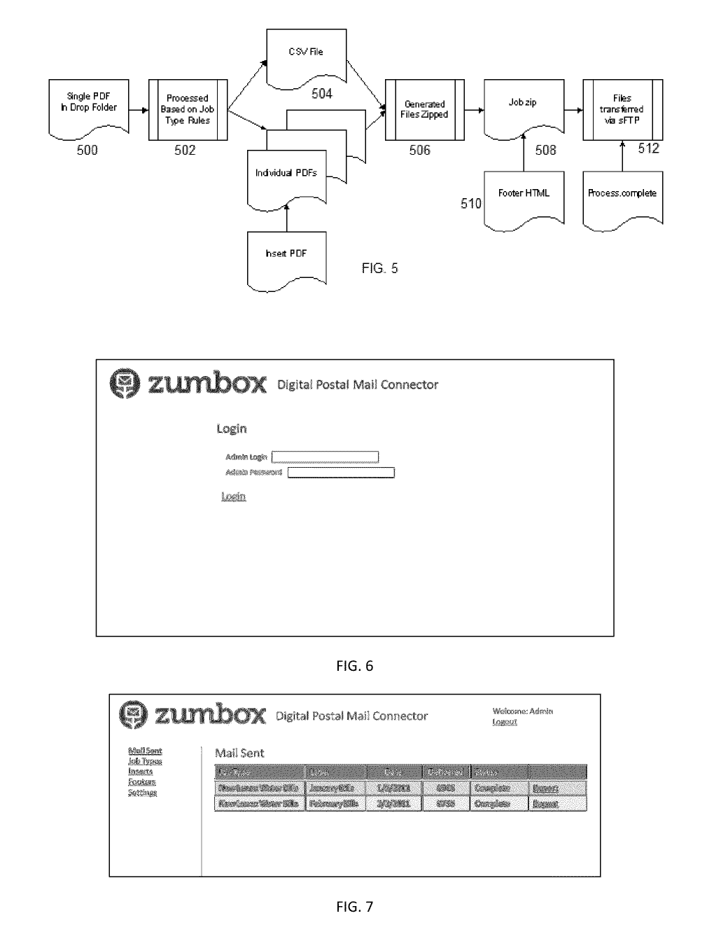

FIGS. 6-13 illustrate representative display interfaces that comprise the web-based interface exported by the gateway. This interface enables an administrator to create one or more mailer jobs. These display interfaces are merely representative and should not be taken to limit the disclosed subject matter. As has been described, the DPMG mailer processing wizard preferably is implemented as software. A local management console exports an interface (secured by username and password) that provides the wizard, which enables the user to create new job types easily and efficiently, configure jobs, launch jobs, provide reports, and the like. Once a job is configured, the user copies the PDF document (the mailpiece) into a drop folder, and the system processes and sends the mail by secure FTP to the web-based platform. The platform “delivers” the mail immediately, i.e., by placing the mail in one or more recipient electronic mailboxes (an SSL-secured web page or pages accessible by an end user subscriber to the paperless service). In addition, using the wizard, the user can preview and approve mailings, and receive alerts when mail processing has been completed by the platform. The user also can view reports and paper suppression requests the local management console.

FIG. 6 illustrates the DPMG sign-in display interface on initial startup.

System is contacted on a particular local IP address, such as 1.1.1.1:8080

Admin login is displayed
Default Login “Admin”
Default Password “Admin”

Login link
Verifies user credentials
   If Valid
      Logs user in and takes user to Main Dashboard
   If Not Valid
      Gives user invalid login error

FIG. 7 illustrates a representative mail sent display interface showing a mail sent table:

Shows all jobs run for this user

Columns
Job Type—Type of job that was run
Label—The label of the individual job
Date—The date the job was started
Delivered—The number of records created by the job
Status—the status of the job (complete|Processing)

Action Links—Only shown if the job is completed
Report Link—Shows the response report

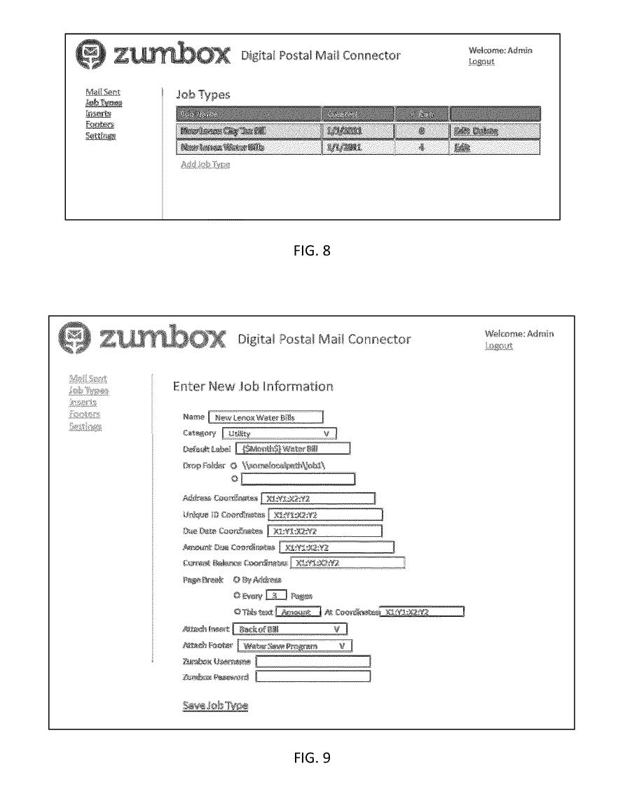

FIG. 8 illustrates a representative job type display interface showing the job types that have been provisioned in this example scenario:

Shows all job types created for this user

Columns
Job Name—Name created for this Job
Created—Date Job Type created
#Run—the number of jobs run for this job type
Action Links
   Edit—Opens the job for editing
   Delete—deletes the job type
      Not shown if there is a job processed

Add Job Type Link
Takes user to new job type entry form

FIG. 9 illustrates a first embodiment of a display interface for use in entering new job information:

Fields
Name—Name of the Job
Category—Drop down of the following categories
   Utility
Default Label—A text label for the Job
   Can contain some keywords
      {$Month$}—Replaced with current month
      {$Date$}—Replaced with current Date DDMMYYYY
Drop Folder—Folder location to monitor for new PDF files
   Radio Button Options
      System Path—Selected by default by the server
      Network Location—Opens selection window for user to select the folder location
Address Coordinates—XY coordinates for where to extract the delivery name and address
Unique ID Coordinates—XY coordinates for where to extract the unique document ID
Due Date Coordinates—XY coordinates for where to extract the due date
Amount Due Coordinates—XY Coordinates for where to extract the Amount Due
Current Balance Coordinates—XY coordinates for where to extract the Current balance
Page Break—Rules for how to break the PDF into individual pages
   Radio button options
      By Address—Each new address detected starts a new page. No address or same address found on each consecutive page will be appended
      Every X pages—will break the document up at every X pages
      By text Key—will break the document each time that text is found at the specified XY coordinates
Attach Insert—Gives a drop down list of all the currently uploaded inserts
Attach Footer—Gives a drop down list of all the currently uploaded footer files
Service Username—the user's Service sFTP username
Service Password—the user's Service sFTP password

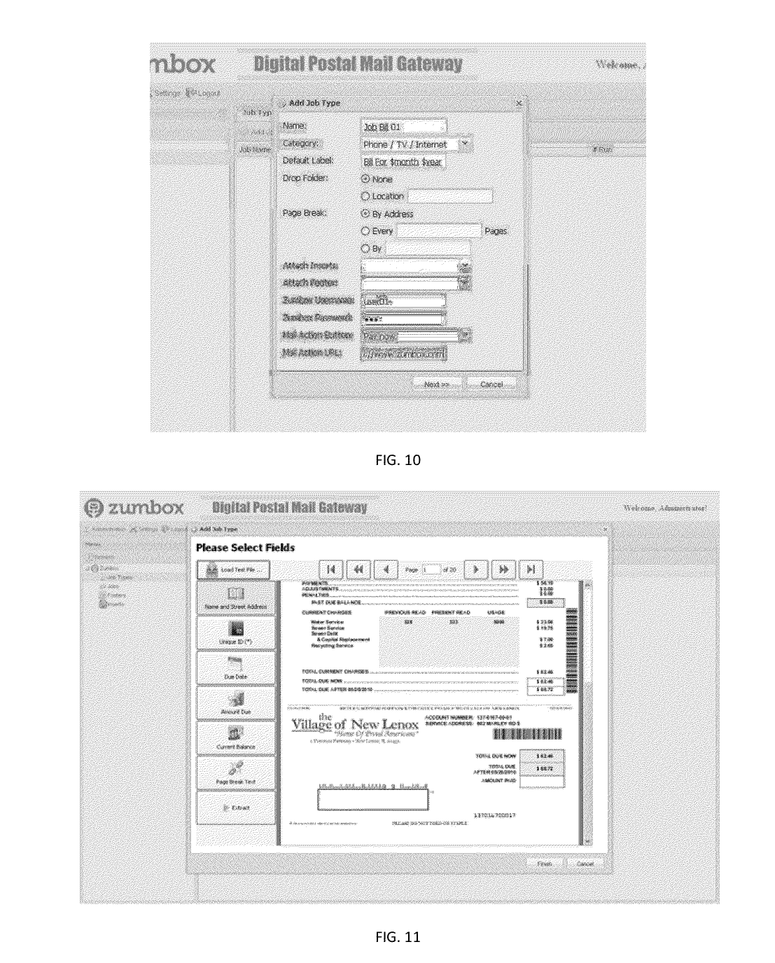

FIG. 10 illustrates an alternative embodiment of the new job type information form. In FIG. 11, which is a continuation of the form in FIG. 10 (once the NEXT button is selected), the user can identify the portions of the mailer to use instead of identifying the page coordinates (as in the first embodiment). In particular, the use can select particular field and associate a portion of the mailer with the field using a select element that can be positioned and re-sized. After the user logs into the DPM gateway, he or she can elect to start a new job, fill out data on how to process the job, and highlight areas of a sample document to identify one or more areas from which the application should extract data (e.g., names, addresses, etc.). The application then uses this information when processing the print stream.

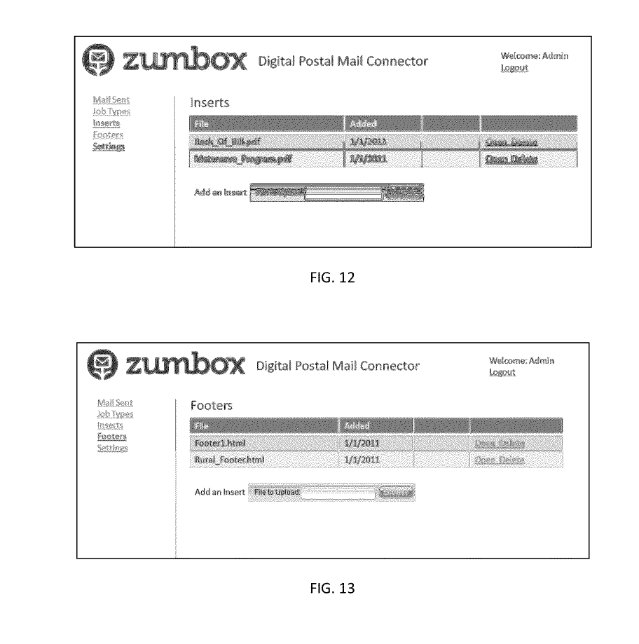

FIG. 12 illustrates a display panel that enables configuration of mailer inserts. FIG. 13 is a display panel that enables configuration of HTML footers to be incorporated into a piece of digital mail.

More generally, the techniques described herein are provided using a set of one or more computing-related entities (systems, machines, processes, programs, libraries, functions, or the like) that together facilitate or provide the described functionality described above. In a typical implementation, the gateway comprises one or more computers. A representative machine comprises commodity hardware, an operating system, an application runtime environment, and a set of applications or processes and associated data, that provide the functionality of a given system or subsystem. As described, the functionality may be implemented in a standalone node, or across a distributed set of machines. If the mailer print stream processor is cloud-based, the DPMG may be offered as a SaaS solution. The DPMG also may be implemented as platform-as-a-service (PaaS) or infrastructure-as-a-service (IaaS).

The disclosed subject matter provides significant advantages. The DPMG is a secure network appliance that automatically and securely delivers (e.g., to consumer households, business entities, and the like) postal mail via a digital channel. Once the gateway is installed and configured, the mailer simply directs its print stream to the installed DPM Gateway, which typically is configured insider the mailer's enterprise firewall and/or DMZ. This configuration allows mailers to achieve paper suppression targets, reduce postage and other mailing related costs, and to improve customer communications. The gateway may be used by any type of mailer, but it provides significant advantages for organizations that send transactional mail to consumer households because it provides direct, secure access to the digital postal network of the paperless postal service provider. In operation, the appliance manages digital delivery with a simple (preferably web-based) interface, without the need for custom IT integration work. Through the digital mail service API, it also delivers detailed reporting about mail recipient usage, including paperless requests, views, payments, printing and discards.

By diverting files headed to print in the manner described above, mailers can push (for delivery) all or substantially all of their files to the service provider. This provides the lowest cost possible for delivery to the digital postal network. In one example business or use case, the delivery of the digital postal mail to the intended consumer is free. In this scenario, which is non-limiting, the service provider then charges the mailer only when users suppress paper, thereby ensuring that any cost to the mailer comes from real monetary savings.

The DPMG appliance enables mailers of any size to offer a digital delivery channel to consumers that dramatically increases paper suppression rates and lowers postage costs.

The DPMG achieves several goals for in-house production mailers: (a) rapid, low-cost deployment with almost no IT resources required, (b) a highly secure, encrypted channel for digital distribution accessed inside the corporate network rather than “in the wild” over the Internet, and (c) if configured, reports and APIs that provide insight into paper suppression, consumer interactions and other consumer mail response and usage details.

The interface between the DPMG and the digital mail platform may be programmatic.

The acronym DPMG is not intended to be limiting.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the disclosed subject matter has been described in the context of a method or process, the subject disclosure also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus.

While given components of the system have been described separately, one of ordinary skill will appreciate that some of the functions may be combined or shared in given instructions, program sequences, code portions, and the like.

Having described our invention, what we now claim is as follows.

1. A method of integrating a mailer entity to a web-based digital postal service, the mailer entity including a network and a print stream processor, the method comprising:
locating a gateway in the network associated with the mailer entity downstream from the print stream processor, the gateway including a hardware element and having a display interface;
configuring a mail job using the display interface, the mail job having a network path in the mailer network;
periodically, scanning for the mail job; and
upon determining that a mail piece is associated with the network path, automatically processing the mail job.

2. The method as described in claim 1 wherein the processing generates content for the mail piece according to a job rule and communicates the mail piece to the digital postal service.

3. The method as described in claim 2 wherein the mail piece is communicated to the digital postal service over a secure connection.

4. The method as described in claim 1 wherein the mail piece is associated with the network path upon receipt of data indicating that a document has been dropped in a display folder associated with the display interface.

5. The method as described in claim 1 wherein the display interface is a web interface.

6. The method as described in claim 1 further including receiving at the gateway data indicative of access to the mail piece by users of the digital mail service.

7. The method as described in claim 6 wherein the data is received over an application programming interface (API) associated with the digital mail service.

8. Apparatus, comprising:
a processor, and
computer memory holding computer program instructions executed by the processor to perform a method, the method comprising:
exposing a display wizard having a drop folder associated therewith;
receiving a piece of mail, as a document, in the drop folder;
in response to the receiving step, automatically creating a digital piece of mail and securely transmitting the digital piece of mail to a digital postal service.
